(19) United States
(12) Patent Application Publication
(10) Pub. No.: US 2005/0216846 A1
(43) Pub. Date: Sep. 29, 2005

(54) Normal versus small screen rendering with given URL

(76) Inventor: Mika Kalenius, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/811,482

(22) Filed: Mar. 26, 2004

(51) Int. Cl. G06F 3/00; G11B 27/00

(52) U.S. Cl. 715/747; 715/746; 715/789; 715/811; 715/718

(57) ABSTRACT

A method and mobile terminal are disclosed for use in a wireless communication system for rendering content on a small display screen. Upon accessing the content a first time, the content is displayed in a first rendering mode. Then the content is provided by the display screen according to a second, user-preferred rendering mode. Subsequently, the content or a revised version thereof is accessed again, and is provided by the display screen to the user in the second, user-preferred rendering mode, without having to access or display the content in the first rendering mode.

### FIELD OF THE INVENTION

The present invention relates to wireless communication, and more particularly to rendering content on a small terminal display screen.

### BACKGROUND OF THE INVENTION

When web sites are accessed using a desktop computer, those web sites are displayed on a screen that is very large compared to the screen of a typical mobile terminal. When the same web sites are accessed using the mobile terminal, those web sites are usually displayed on a relatively small screen, which can cause viewing difficulties. The same is true if the content being displayed is a document stored in the mobile terminal, or a video stream, or any other content displayed on the small screen. A web site or other content that is designed for viewing on a large screen, but that is viewed on a small screen, creates an effect very much like looking at a large nearby mountain through a telescope; it is difficult to get the big picture, and only small portions are visible at one time.

In order to cope with this small screen viewing problem, re-authoring techniques have been proposed, so that web site authors will be able to offer formatting guidance for their web sites in the source code. It has also been proposed to have a new domain extension for content that is formatted for a small mobile screen. However, such techniques are rarely used today and would require redesign of countless web sites.

Another approach to the small screen viewing problem is for a mobile terminal to use a rendering algorithm, in order to render a web page in a way that is more palatable to a mobile terminal user. This is called small screen rendering (SSR), and is here distinguished from re-authoring which is controlled mostly at the provider side instead of at the mobile terminal side. It is sometimes possible that a combination of SSR and re-authoring will occur.

Various different techniques of SSR have been proposed. For example, Chen et al. (“Detecting Web Page Structure for Adaptive Viewing on Small Form Factor Devices,” published in WWW 2003, May 20-24, 2003, Budapest, Hungary, pages 225-232) have suggested to provide an overview of a web page, and then the user selects a desired portion to zoom in on. This rendering technique is hereinafter referred to as thumbnail small screen rendering (TSSR).

Another SSR technique has been developed by Opera Software (see www.opera.com/products/smartphone/smallscreen). Opera's small-screen rendering technology intelligently reformats web sites to fit inside the screen width, thereby eliminating the need for horizontal scrolling. This rendering technique is hereinafter referred to as narrow small screen rendering (NSSR). All the content and functionality is still available, and it is only the layout of the page that is changed.

Smart phone applications and particularly browsers should have at least two different modes for viewing given content: normal and at least one small screen rendering (SSR) mode. In normal mode, the data (in the form of a web-page, Adobe Acrobat pdf document, et cetera) is rendered to the screen in the same way that it has been designed for large displays, so the small screen user must do considerable horizontal scrolling in order to read parts of the document using the small display. However, in NSSR mode, data is reformatted and shown to the user in such a way that there is only a need for vertical scrolling. NSSR is particularly useful for reading text, so that the user will not have to scroll horizontally to read the end of every line of text. In addition to normal viewing and SSR viewing, a smart phone will often be able to comply with re-authoring instructions so that reformatting is performed without an SSR algorithm.

In practice, the user of a small mobile terminal screen will find that some web sites or documents are best viewed in the normal (i.e. traditional) way without any SSR performed by the mobile terminal, or in a re-authored format without SSR. The user of a small mobile terminal screen will also find that some web sites or documents are best viewed with SSR, and different types of SSR may work better for different web sites or documents (e.g. TSSR may work best for one web site while NSSR may work best for another web site). The main problem with the state of the art is that the browser or application typically shows all pages and documents either using normal mode or using one single small screen rendering mode (SSR).

The rendering mode is an application level setting that can be changed, but there is no way at present to associate a given rendering method with a given web page or document. Traditional desktop browser and desktop applications do not have this problem because they only support the normal rendering mode. However, new smart phones have browsers and applications (e.g. in the S60 Platform) that will increasingly encounter this problem.

### SUMMARY OF THE INVENTION

In order to view content accessed by a small user display (e.g. by sending or downloading the content to the display's terminal), the user may define a rendering mode associated with the origin of the respective content. The content may change between downloads of that content, but the rendering mode associated with the origin will not change, unless the user decides to change the rendering mode.

The origin (e.g. the address) of the content can specify a file locally in the device, or it can specify a network address. The rendering mode is defined by the user of the device and it can be changed later on (i.e. the method can be performed iteratively if the user has a change of preference). The user can also assign a default rendering mode for all files of a particular type, such as one default rendering mode for pdf files, one default rendering mode for html files, one default rendering mode for all files in a particular folder, et cetera. The user is then able to modify the default mode after the user experiments with different rendering modes for particular content.

The basic idea of this invention is to enable browsers and other applications to associate and save rendering modes based on the given URL (e.g. www.nokia.com) and/or document location information (e.g. c:\docs\pdfs\document.pdf). The rendering mode information can be associated in the following two situations, among others:

1) when the user is viewing a web page or document from a given URL or location, then the browser or application can provide a method for the user to define that this web page or document and/or this URL or location henceforth uses a particular rendering method, and then the browser or application saves this information to an internal storage medium;

2) when the user saves a bookmark to a given web page or document that is available from a given URL or location, then the user can define the rendering mode that is used with the associated bookmark.

When the user loads the web page/document from a given URL/location in the future (either directly or via bookmarks), then the browser/application can apply the saved rendering method when rendering the document/data for the user. Also, if the user changes the rendering mode while viewing the web page/document, then the software can inquire (e.g. when the user closes the document) whether the user would like to save the changed rendering mode correlating the rendering mode of the web page/document to its URL/location.

When the user first looks at a web page/document, it can be displayed according to a user-specified default rendering mode. However, even if no re-authoring has occurred, still the source code may indicate a different default rendering mode. In any event, the user can then experiment with different modes, and modify the default rendering mode to conform with normal rendering, re-authored rendering, or some form of SSR. When the user next accesses the web page/document, that web page/document will automatically start out in the rendering mode saved by the user last time, even if the content of the web page/document has been changed by someone else during the time interval when the user was not accessing it.

With this implementation the user can save time, and in some cases also reduce the amount of data downloaded to the terminal. With web pages/documents that require a specific rendering mode, the user will get the optimal rendering mode in the first attempt and therefore will get information in the right format as fast as possible.

### BRIEF DESCRIPTION OF THE DRAWINGS

FIG. 1 is a flow chart illustrating a method according to the present invention.

FIG. 2 is a block diagram illustrating a mobile terminal according to the present invention.

### DETAILED DESCRIPTION OF THE INVENTION

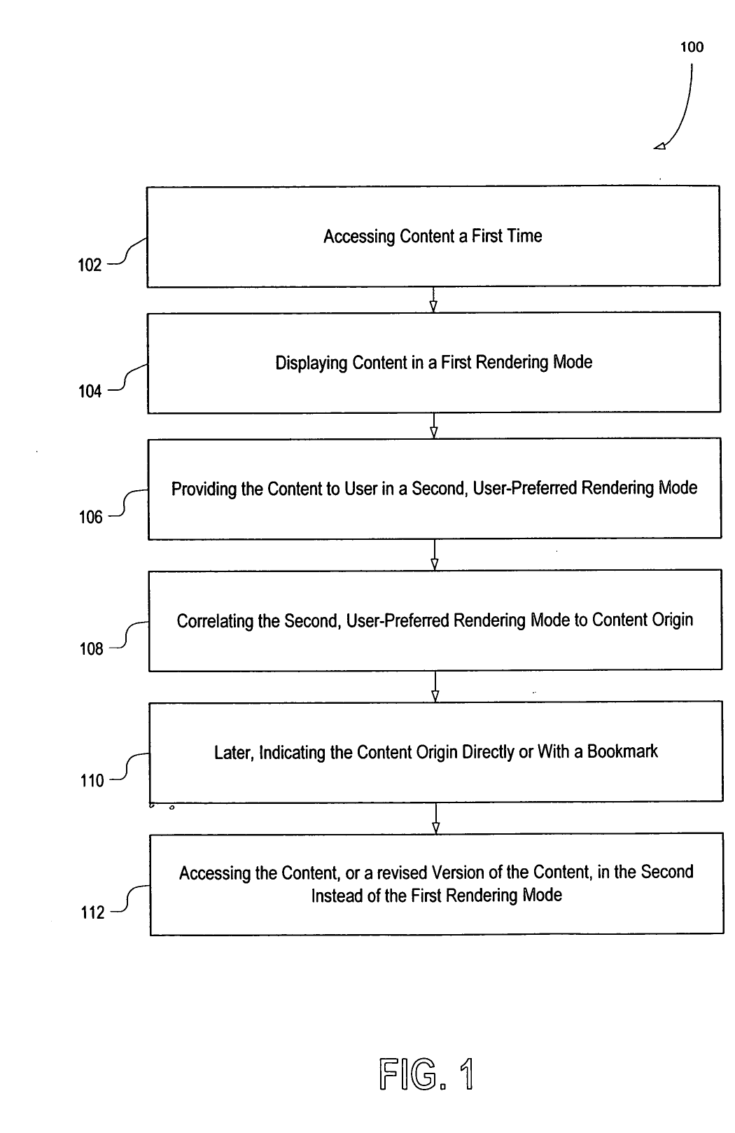

The present invention can be further appreciated by reference to the accompanying figures. FIG. 1 shows a method 100 according to an embodiment of the present invention. The method begins by accessing 102 content a first time, and displaying 104 that content in a first rendering mode. This need not be the very first time that the content is ever accessed, but rather refers to a particular one of those times when the content is accessed. Then the content is shown (i.e. provided) 106 to the user according to a second, user-preferred rendering mode. The second, user-preferred rendering mode is correlated 108 to an origin of the content. Subsequently, the user indicates the content origin so as to again access 112 the content (or a revised version of the content), at which point the content will be accessed by the user in the second, user-preferred rendering mode, without having to access or display the content in the first rendering mode. In other words, the user will not have to again indicate that the user prefers a small screen rendering mode for that content, nor indicate which small screen rendering mode is preferred for that content.

When the user indicates 110 the content origin, this can be done by directly typing a uniform resource locator (URL) or by directly typing a network path, or by indirectly clicking on a hyperlink, or by indirectly using a bookmark. Typically, the content origin will be accompanied by (or include) an indication of the type of content; for example, a URL for an adobe acrobat file will end with the letter “pdf.” Thus, it is possible for the display 104 to be performed according to a default rendering mode that is specified by a mobile terminal for a particular type of the content. Then, the user might find that a different rendering mode is preferred, and be provided 106 with that preferred mode that is desired instead of the default mode. The default modes could be modifiable by a mobile terminal user, and they could also be subject to modification (e.g. override) by instructions contained in the content (e.g. in downloaded source code). In either case, the user would have an opportunity to see the content in a first rendering mode, switch to a second rendering mode, and thenceforth have the second rendering mode activated whenever the user accesses the same web page, file, or other embodiment of the content.

Once the user has selected the second, user-preferred rendering mode, it may be that less data needs to be downloaded in order to present the content in that second, user-preferred rendering mode, as compared to the first rendering mode. Thus, content accessed via the internet would depend upon what rendering mode is employed, and download times can be reduced.

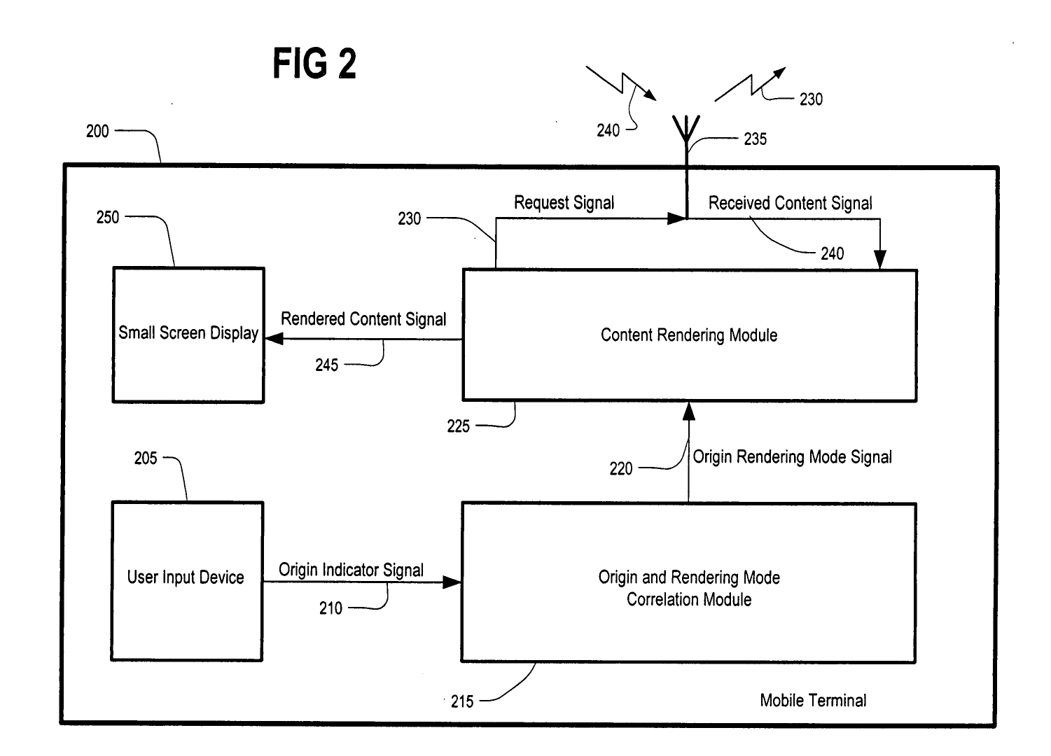

Referring now to FIG. 2, a mobile terminal 200 for rendering content on a display screen is diagrammed. The display screen 250 is responsive to the rendered content signal 245, and is for displaying the content in a rendering mode. The content rendering module 225 is for providing the rendered content signal 245 in response to a received content signal 240 and an origin rendering mode signal 220. The origin rendering mode signal 220 correlates the rendering mode to the origin of the content. Of course, the received signal 240 is in response to a request signal 230 to a network, and both signals are conveyed via a transceiver 235.

The mobile terminal 200 further includes an origin and rendering mode correlation module 215, which responds to an origin indicator signal 210, and provides the origin rendering mode signal 220. A user input device 205 provides the origin indicator signal 210 indicative of the origin of the content.

Although the origin and rendering mode correlation module 215 is for correlating the rendering mode to the origin of the content, if no such correlation has been established by the user then this module 215 can correlate the rendering mode to a default rendering mode for a particular type of content. For example, if a URL ends with “pdf” then one rendering mode would be used as a default, but if the URL ends with “doc” then another default rendering mode would be used.

It is to be understood that all of the present figures, and the accompanying narrative discussions of best mode embodiments, do not purport to be completely rigorous treatments of the method, terminal, and system under consideration. A person skilled in the art will understand that the steps and signals of the present application represent general cause-and-effect relationships that do not exclude intermediate interactions of various types, and will further understand that the various steps and structures described in this application can be implemented by a variety of different combinations of hardware and software which need not be further detailed herein.

1. A method of rendering content to be viewed on a display screen, comprising:
upon accessing the content a first time, displaying the content in a first rendering mode,
showing the content according to a second, user-preferred rendering mode, and
subsequently accessing the content, or a revised version of the content, in the second, user-preferred rendering mode without displaying the content in the first rendering mode.

2. The method of claim 1, wherein, prior to the step of subsequently accessing the content, the second user-preferred rendering mode is correlated to an origin of the content, and
wherein the step of subsequently accessing the content requires designation of the origin of the content either directly or indirectly.

3. The method of claim 2, wherein the origin is indicated by a uniform resource locator, and the content is accessed via the internet.

4. The method of claim 1, wherein the first rendering mode is a default rendering mode that is specified for a particular type of the content, or is specified by a provider of the content.

5. The method of claim 4, wherein the default rendering mode has been set by a user for the particular type of the content.

6. The method of claim 1, wherein the second user-preferred rendering mode comprises at least one of the group consisting of normal rendering mode, re-authored mode, and at least one small screen rendering mode.

7. The method of claim 6, wherein the at least one small screen rendering mode includes thumbnail small screen rendering or narrow small screen rendering or both.

8. The method of claim 2, wherein the origin of the content is indicated indirectly by selecting a bookmark or hyperlink.

9. The method of claim 3, wherein the content accessed via the internet requires downloading an amount of data dependent upon what rendering mode is employed.

10. The method of claim 1, wherein the method is performed iteratively, if the user has a change of preference.

11. A computer-readable medium encoded with a software data structure for performing the method of claim 1.

12. A terminal for rendering content on a display screen, comprising:
a display screen, responsive to a rendered content signal, for displaying the content in a rendering mode; and
a content rendering module, for providing the rendered content signal in response at least to an origin rendering mode signal,
wherein the origin rendering mode signal correlates the rendering mode to the origin of the content.

13. The terminal of claim 12 wherein the terminal is a mobile terminal, further comprising:
an origin and rendering mode correlation module, responsive to an origin indicator signal, for providing the origin rendering mode signal; and
a user input device, for providing the origin indicator signal indicative of the origin of the content.

14. The terminal of claim 12, wherein the origin is identifiable by a uniform resource locator, and the content is accessible via the internet.

15. The mobile terminal of claim 13, wherein the origin and rendering mode correlation module is for correlating the rendering mode to the origin of the content if a correlation to the origin is available, and otherwise the origin and rendering mode correlation module is for correlating the rendering mode to a default rendering mode for a particular type of content.

16. The terminal of claim 12, wherein the rendering mode comprises at least one of the group consisting of normal rendering mode, re-authored mode, and at least one small screen rendering mode.

17. The terminal of claim 16, wherein the at least one small screen rendering mode includes thumbnail small screen rendering or narrow small screen rendering or both.

18. A method of rendering content to be viewed on a display screen, comprising:
upon accessing the content a first time, displaying the content in a first rendering mode,
showing the content according to a second, user-preferred rendering mode, and
subsequently accessing the content, or a revised version of the content, in the second, user-preferred rendering mode without further indication of a user preference.
